(19) United States
(12) Patent Application Publication
(10) Pub. No.: US 2023/0154463 A1
(43) Pub. Date: May 18, 2023

(54) METHOD OF REORGANIZING QUICK COMMAND BASED ON UTTERANCE AND ELECTRONIC DEVICE THEREFOR

(71) Applicant: SAMSUNG ELECTRONICS CO, LTD., Suwon-si (KR)

(72) Inventors: Jisun CHOI, Suwon-si (KR); Seolhee KIM, Suwon-si (KR); Jaeyung YEO, Suwon-si (KR)

(73) Assignee: SAMSUNG ELECTRONICS CO, LTD., Suwon-si (KR)

(21) Appl. No.: 17/989,595

(22) Filed: Nov. 17, 2022

Related U.S. Application Data
(63) Continuation of application No. PCT/KR2022/016284, filed on Oct. 24, 2022.

(30) Foreign Application Priority Data
Nov. 17, 2021 (KR) 1020210158233
Dec. 23, 2021 (KR) 1020210186255

(51) Int. Cl. G10L 15/22; G10L 15/18

(52) U.S. Cl. CPC G10L 15/22; G10L 15/1815; G10L 2015/088

(57) ABSTRACT

An electronic device includes a processor, and memory that stores instructions. The processor executes the instructions to acquire utterance data of a user, the utterance data including a quick command and an edit command for editing a task, identify a plurality of tasks associated with the quick command by using the quick command, edit the tasks associated with the quick command by excluding one task from among the plurality of tasks or adding a new task to the plurality of tasks based on the edit command, and perform the edited plurality of tasks.

### CROSS-REFERENCE TO RELATED APPLICATION

This application is a bypass continuation of International Application No. PCT/KR2022/016284 designating the United States, filed on Oct. 24, 2022, in the Korean Intellectual Property Receiving Office and claims priority from Korean Patent Application No. KR 10-2021-0158233, filed on Nov. 17, 2021, and Korean Patent Application No. KR 10-2021-0186255, filed on Dec. 23, 2021, the disclosures of which are incorporated by reference herein in their entireties.

### BACKGROUND

### 1. Field

The Various example embodiments disclosure relates to a method and an electronic device for reorganizing a quick command based on an utterance of a voice command.

### 2. Description of Related Art

Techniques for controlling an electronic device based on a voice command of a user are being widely used. For example, the electronic device may include a voice assistant configured to identify the user's intent from the user's utterance and perform an action corresponding to the identified intent. The user may easily control the electronic device through the voice command.

With more and more internet-of-things (IoT) devices, a technology of allowing a user to control another electronic device, such as an IoT device, through a voice command is widely used. A listener device, such as a mobile phone or artificial intelligence (AI) speaker, may acquire a user's utterance and control other IoT devices based on the utterance via a network such as the Internet. For example, when the user's utterance is “turn off the lights in the living room”, the voice assistant may turn off the light located in the living room of the house of the user.

### SUMMARY

In order to increase user convenience, the voice assistant may be configured to perform several actions corresponding to one utterance. The voice assistant may store information about a plurality of actions mapped to one utterance. The voice assistant may be configured to perform a plurality of mapped actions if a specified utterance is received. For example, a plurality of actions such as “today's schedule reminder”, “today's weather alert”, and “today's stock index notification” may be mapped to the utterance “briefing”. Instead of performing each utterance corresponding to several actions, the user may simply utter “briefing” to check information on schedules, weather, and stock indices.

The user may want to edit a plurality of mapped actions. For example, the user may want to perform only some of the plurality of mapped actions. For another example, the user may want to perform an additional action along with a plurality of mapped actions. Instead of entering the edit menu of the electronic device in order to edit the mapped actions, the user may want to edit the actions in real time. In addition, the user may want to temporarily edit the actions or to save the change depending on the edit.

Various example embodiments of the disclosure may provide an electronic device and a method for solving the above-described problems.

### SUMMARY

According to an aspect of the disclosure, there is provided an electronic device including a memory configured to store one or more instructions and a processor configured to execute the one or more instructions to: obtain utterance data corresponding to voice command of a user, the utterance data including a quick command and an edit command, identify a task set including a plurality of tasks associated with the quick command based on the quick command, edit the task set associated with the quick command by excluding a first task from among the plurality of tasks or adding a new task to the task set based on the edit command and perform the edited task set.

According to an aspect of the disclosure, there is provided a method of reorganizing a quick command of an electronic device, the method including: obtaining utterance data corresponding to a voice command of a user, the utterance data including a quick command and an edit command for editing a task, identifying a task set including a plurality of tasks associated with the quick command based on the quick command, editing the task set associated with the quick command by excluding a first task from among the plurality of tasks or adding a new task to the task set based on the edit command and performing the edited task set.

According to an aspect of the disclosure, there is provided an electronic device including: a memory configured to store one or more instructions; and a processor configured to execute the one or more instructions to: obtain a voice command from a user, the voice command including a first command and a second command adjacent to the first command, identify a task set including a plurality of tasks associated with the first command, generate a modified task set based on the second command; and control to perform one or more operations based on the modified task set.

The electronic device according to an example embodiment of the disclosure may provide a method of reorganizing an action associated with a quick command in real time.

The electronic device according to an example embodiment of the disclosure may increase user convenience.

The electronic device according to an example of the disclosure may improve user convenience, thereby increasing the frequency of use of the electronic device.

The electronic device according to an example of the disclosure may reduce a user input step through real-time reorganizing of actions.

### BRIEF DESCRIPTION OF THE DRAWINGS

FIG. 1 is a block diagram illustrating an electronic device in a network environment according to various example embodiments.

FIG. 2 is a block diagram illustrating an integrated intelligence system according to an example embodiment.

FIG. 3 is a diagram illustrating a form in which information on relation between concepts and actions is stored in a database, according to an example embodiment.

FIG. 4 is a diagram illustrating a user terminal displaying a screen for processing a voice input received through an intelligent app, according to an example embodiment.

FIG. 5 illustrates a system for performing an action based on an utterance, according to an example embodiment.

FIG. 6 illustrates a multi-device environment according to an example embodiment.

FIG. 7 illustrates a block diagram of an electronic device according to an example embodiment.

FIG. 8 illustrates a system for quick command reorganization according to an example embodiment.

FIG. 9 illustrates a flowchart of a method of performing a task in an example embodiment.

FIG. 10 illustrates a flowchart of a method of performing a task according to an example embodiment.

FIG. 11 illustrates a user interface (UI) for editing a quick command according to an example embodiment.

FIG. 12 illustrates an execution screen of a quick command according to an example embodiment.

FIG. 13 illustrates an edited execution screen of a quick command according to an example embodiment.

FIG. 14 illustrates a UI for saving a new quick command according to an example embodiment.

### DETAILED DESCRIPTION

Hereinafter, various example embodiments disclosed in the disclosure will be described with reference to the accompanying drawings. However, this is not intended to limit the disclosure to the specific embodiments, and it is to be construed to include various modifications, equivalents, and/or alternatives of embodiments of the disclosure.

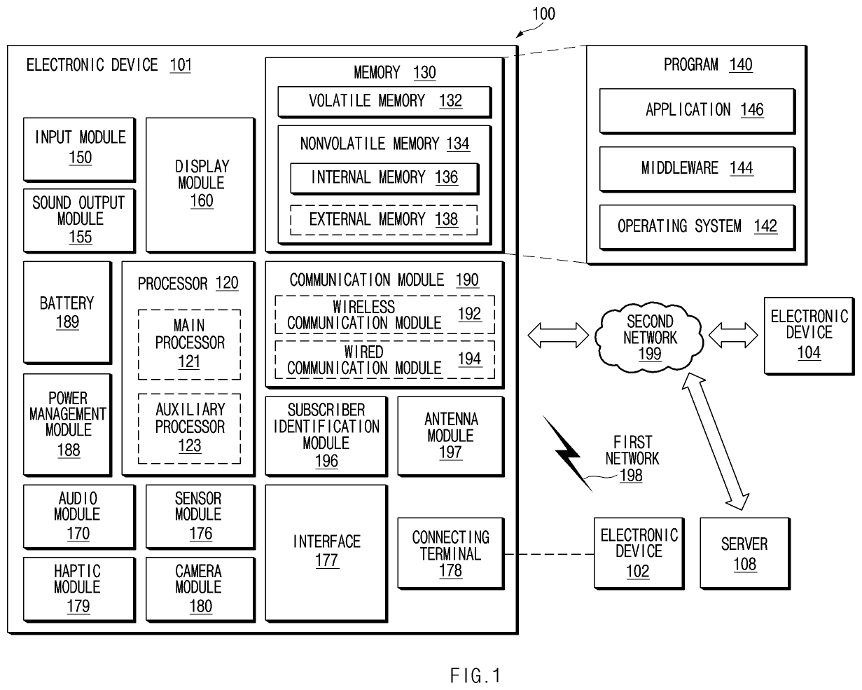

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thererto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

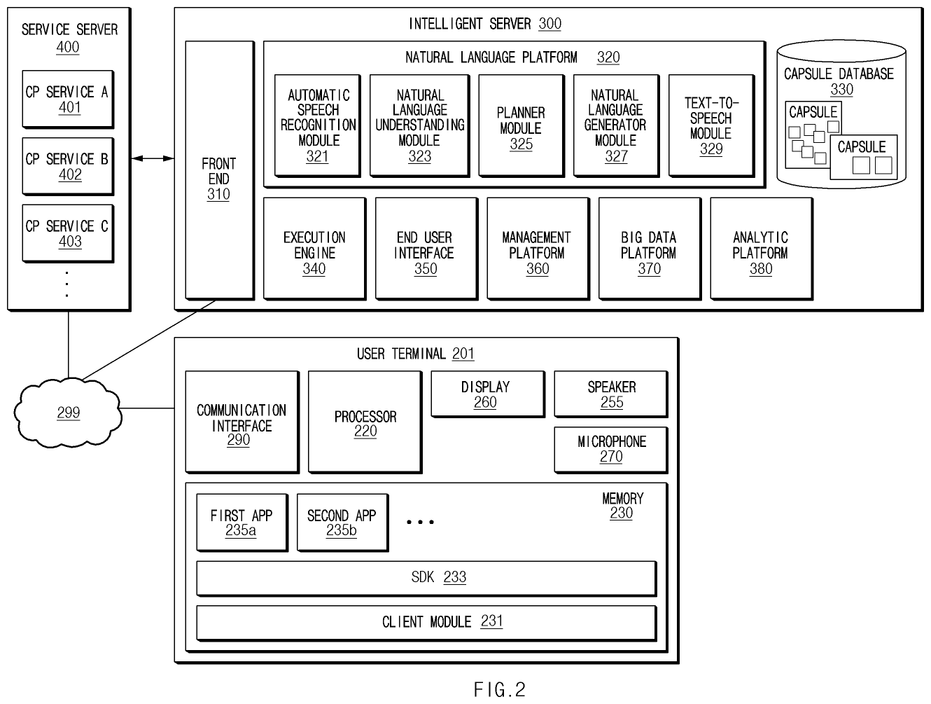

FIG. 2 is a block diagram illustrating an integrated intelligence system according to an example embodiment.

Referring to FIG. 2, the integrated intelligent system according to an example embodiment may include a user terminal 201, an intelligent server 300, and a service server 400.

The user terminal 201 (e.g., the electronic device 101 of FIG. 1) according to an example embodiment may be a terminal device (or electronic device) connectable to the Internet. For example, the electronic device may be any one of a mobile phone, a smartphone, or a personal digital assistant (PDA), a laptop computer, a television (TV), a home appliance, a wearable device, a head mounted device (HMD), or a smart speaker. However, the disclosure is not limited thereto, and as such the user terminal 201 may be another type of electronic device.

According to the example embodiment, the user terminal 201 may include a communication interface 290, a microphone 270, a speaker 255, a display 260, a memory 230, and/or a processor 220. The components listed above may be operatively or electrically connected to each other. However, the disclosure is not limited thereto, and as such the other components may be included in the user terminal 201.

The communication interface 290 (e.g., the communication module 190 of FIG. 1) may be configured to be connected to an external device to transmit/receive data. The microphone 270 (e.g., the audio module 170 of FIG. 1) may receive a sound (e.g., an utterance of the user) and convert the sound into an electrical signal. The speaker 255 (e.g., the sound output module 155 of FIG. 1) may output the electrical signal as a sound (e.g., voice). The display 260 (e.g., the display module 160 of FIG. 1) may be configured to display an image or video. The display 260 according to an example embodiment may also display a graphic user interface (GUI) of an executed app (or an application program).

The memory 230 (e.g., the memory 130 of FIG. 1) according to an example embodiment may store a client module 231, a software development kit (SDK) 233, and a plurality of applications. The client module 231 and the SDK 233 may constitute a framework (or a solution program) for performing general functions. In addition, the client module 231 or the SDK 233 may constitute a framework for processing a voice input.

The plurality of applications (e.g., first app 235a and second app 235b) may be programs for performing a specified function. According to an example embodiment, the plurality of applications may include a first app 235a and/or a second app 235b. According to an example embodiment, each of the plurality of applications may include a plurality of operations for performing a specified function. For example, the applications may include an alarm app, a message app, and/or a schedule app. According to an example embodiment, the plurality of applications may be executed by the processor 220 to sequentially execute at least some of the plurality of operations.

The processor 220 according to an example embodiment may control the overall operations of the user terminal 201. For example, the processor 220 may be electrically connected to the communication interface 290, the microphone 270, the speaker 255, and the display 260 to perform a specified operation. For example, the processor 220 may include at least one processor.

The processor 220 according to an example embodiment may also execute a program stored in the memory 230 to perform a specified function. For example, the processor 220 may execute at least one of the client module 231 and the SDK 233 to perform the following operations for processing a voice input. The processor 220 may control operations of a plurality of applications through, for example, the SDK 233. The following operations described as operations of the client module 231 or SDK 233 may be operations performed by execution of the processor 220.

The client module 231 according to an example embodiment may receive a voice input. For example, the client module 231 may receive a voice signal corresponding to an utterance of the user detected through the microphone 270. The client module 231 may transmit the received voice input (e.g., voice signal) to the intelligent server 300. The client module 231 may transmit, to the intelligent server 300, state information about the user terminal 201 together with the received voice input. The state information may be, for example, execution state information for an app.

The client module 231 according to an example embodiment may receive a result corresponding to the received voice input from the intelligent server 300. For example, if the intelligent server 300 may calculate a result corresponding to the received voice input, the client module 231 may receive a result corresponding to the received voice input. The client module 231 may display the received result on the display 260.

The client module 231 according to an example embodiment may receive a plan corresponding to the received voice input. The client module 231 may display, on the display 260, execution results of a plurality of actions of the app according to the plan. The client module 231 may, for example, sequentially display, on the display 260, the execution results of the plurality of actions. For another example, the user terminal 201 may display only some execution results of the plurality of actions (e.g., the result of the last action) on the display 260.

According to an example embodiment, the client module 231 may receive a request for obtaining information necessary for calculating a result corresponding to the voice input from the intelligent server 300. According to an example embodiment, the client module 231 may transmit the necessary information to the intelligent server 300 based on the request. According to an example embodiment, the client module 231 may transmit the necessary information to the intelligent server 300 in response to the request.

The client module 231 according to an example embodiment may transmit, to the intelligent server 300, result information obtained by executing the plurality of actions according to the plan. The intelligent server 300 may confirm that the voice input received by using the result information has been correctly processed.

The client module 231 according to an example embodiment may include a speech recognition module. According to an example embodiment, the client module 231 may recognize a voice input to perform a limited function through the speech recognition module. For example, the client module 231 may execute an intelligent app for processing a specified voice input (e.g., wake up!) by performing an organic operation in response to the voice input.

The intelligent server 300 according to an example embodiment may receive information related to the voice input of the user from the user terminal 201 through a network 299 (e.g., the first network 198 and/or the second network 199 of FIG. 1). According to an example embodiment, the intelligent server 300 may change data related to the received voice input into text data. According to an example embodiment, the intelligent server 300 may generate at least one plan for performing a task corresponding to the voice input of the user based on the text data.

According to one embodiment, the plan may be generated by an artificial intelligent (AI) system. The artificial intelligence system may be a rule-based system, and may be a neural network-based system (e.g., a feedforward neural network (FNN), and/or a recurrent neural network (RNN)). Alternatively, the artificial intelligence system may be a combination of those described above, or another artificial intelligence system other than those described above. According to an example embodiment, the plan may be selected from a set of predefined plans or may be generated in real time based on a user request. According to an example embodiment, the plan may be selected from a set of predefined plans or may be generated in real time in response to a user request. For example, the artificial intelligence system may select at least one plan from among a plurality of predefined plans.

The intelligent server 300 according to an example embodiment may transmit a result according to the generated plan to the user terminal 201 or transmit the generated plan to the user terminal 201. According to an example embodiment, the user terminal 201 may display a result according to the plan on the display 260. According to an example embodiment, the user terminal 201 may display, on the display 260, a result obtained by executing actions according to the plan.

The intelligent server 300 according to an example embodiment may include a front end 310, a natural language platform 320, a capsule database 330, an execution engine 340, an end user interface 350, a management platform 360, a big data platform 370, and an analytic platform 380. However, the disclosure is not limited to the components illustrated in FIG. 2. As such, according to another example embodiment, the intelligent server 300 may include other component and/or one or more of the components in FIG. 2 may be omitted.

The front end 310 according to an example embodiment may receive a voice input received by the user terminal 201 from the user terminal 201. The front end 310 may transmit a response corresponding to the voice input to the user terminal 201.

According to an example embodiment, the natural language platform 320 may include an automatic speech recognition module (ASR module) 321, a natural language understanding module (NLU module) 323, a planner module 325, a natural language generator module (NLG module) 327, and/or a text-to-speech module (TTS module) 329.

The automatic speech recognition module 321 according to an example embodiment may convert the voice input received from the user terminal 201 into text data. The natural language understanding module 323 according to an example embodiment may determine an intent of the user by using text data of the voice input. For example, the natural language understanding module 323 may determine the intent of the user by performing syntactic analysis and/or semantic analysis. The natural language understanding module 323 according to an example embodiment may identify the meaning of words by using linguistic features (e.g., grammatical elements) of morphemes or phases, and determine the intent of the user by matching the meaning of the identified word with the intent.

The planner module 325 according to an example embodiment may generate a plan by using the intent and parameters determined by the natural language understanding module 323. According to an example embodiment, the planner module 325 may determine a plurality of domains required to perform a task based on the determined intent. The planner module 325 may determine a plurality of actions included in each of the plurality of domains determined based on the intent. According to an example embodiment, the planner module 325 may determine parameters required to execute the determined plurality of actions or a result value output by the execution of the plurality of actions. The parameter and the result value may be defined as a concept of a specified format (or class). Accordingly, the plan may include a plurality of actions and/or a plurality of concepts determined by the intent of the user. The planner module 325 may determine the relationship between the plurality of actions and the plurality of concepts in stages (or hierarchically). For example, the planner module 325 may determine an execution order of the plurality of actions determined based on the intent of the user based on the plurality of concepts. In other words, the planner module 325 may determine the execution order of the plurality of actions based on parameters required for execution of the plurality of actions and results output by the execution of the plurality of actions. Accordingly, the planner module 325 may generate a plan including information (e.g., ontology) on the relation between a plurality of actions and a plurality of concepts. The planner module 325 may generate the plan by using information stored in the capsule database 330 in which a set of relationships between concepts and actions is stored.

The natural language generator module 327 according to an example embodiment may change specified information into a text format. The information changed to the text format may be in the form of natural language utterance. The text-to-speech module 329 according to an example embodiment may change information in a text format into information in a voice format.

According to an example embodiment, some or all of the functions of the natural language platform 320 may be implemented in the user terminal 201 as well. For example, the user terminal 201 may include an automatic speech recognition module and/or a natural language understanding module. After the user terminal 201 recognizes a voice command of the user, text information corresponding to the recognized voice command may be transmitted to the intelligent server 300. For example, the user terminal 201 may include a text-to-speech module. The user terminal 201 may receive text information from the intelligent server 300 and output the received text information as voice.

The capsule database 330 may store information on relationships between a plurality of concepts and actions corresponding to a plurality of domains. A capsule according to an example embodiment may include a plurality of action objects (or action information) and/or concept objects (or concept information) included in the plan. According to an example embodiment, the capsule database 330 may store a plurality of capsules in the form of a concept action network (CAN). According to an example embodiment, the plurality of capsules may be stored in a function registry included in the capsule database 330.

The capsule database 330 may include a strategy registry in which strategy information necessary for determining a plan corresponding to a voice input is stored. The strategy information may include reference information for determining one plan when there are a plurality of plans corresponding to the voice input. According to an example embodiment, the capsule database 330 may include a follow up registry in which information on a subsequent action for suggesting a subsequent action to the user in a specified situation is stored. The subsequent action may include, for example, a subsequent utterance. According to an example embodiment, the capsule database 330 may include a layout registry that stores layout information regarding information output through the user terminal 201. According to an example embodiment, the capsule database 330 may include a vocabulary registry in which vocabulary information included in the capsule information is stored. According to an example embodiment, the capsule database 330 may include a dialog registry in which information regarding a dialog (or interaction) with a user is stored. The capsule database 330 may update a stored object through a developer tool. The developer tool may include, for example, a function editor for updating an action object or a concept object. The developer tool may include a vocabulary editor for updating the vocabulary. The developer tool may include a strategy editor for generating and registering strategies for determining plans. The developer tool may include a dialog editor for generating a dialog with the user. The developer tool may include a follow up editor that may edit follow-up utterances that activate subsequent goals and provide hints. The subsequent goal may be determined based on a currently set goal, a user's preference, or an environmental condition. In an example embodiment, the capsule database 330 may be implemented in the user terminal 201 as well.

The execution engine 340 according to an example embodiment may calculate a result by using the generated plan. The end user interface 350 may transmit the calculated result to the user terminal 201. Accordingly, the user terminal 201 may receive the result and provide the received result to the user. The management platform 360 according to an example embodiment may manage information used in the intelligent server 300. The big data platform 370 according to an example embodiment may collect user data. The analytic platform 380 according to an example embodiment may manage the quality of service (QoS) of the intelligent server 300. For example, the analytic platform 380 may manage the components and processing speed (or efficiency) of the intelligent server 300.

The service server 400 according to an example embodiment may provide a specified service (e.g., food order or hotel reservation) to the user terminal 201. According to an example embodiment, the service server 400 may be a server operated by a third party. The service server 400 according to an example embodiment may provide, to the intelligent server 300, information for generating a plan corresponding to the received voice input. The provided information may be stored in the capsule database 330. In addition, the service server 400 may provide result information according to the plan to the intelligent server 300. The service server 400 may communicate with the intelligent server 300 and/or the user terminal 201 through the network 299. The service server 400 may communicate with the intelligent server 300 through a separate connection. Although the service server 400 is illustrated as one server in FIG. 2, embodiments of the disclosure are not limited thereto. At least one of the respective services 401, 402, and 403 of the service server 400 may be implemented as a separate server.

In the integrated intelligent system described above, the user terminal 201 may provide various intelligent services to the user in response to a user input. The user input may include, for example, an input through a physical button, a touch input, or a voice input.

In an example embodiment, the user terminal 201 may provide a speech recognition service through an intelligent app (or a speech recognition app) stored therein. In this case, for example, the user terminal 201 may recognize a user utterance or a voice input received through the microphone 270, and provide a service corresponding to the recognized voice input to the user.

In an example embodiment, the user terminal 201 may perform a specified operation alone or together with the intelligent server 300 and/or the service server 400, based on the received voice input. For example, the user terminal 201 may execute an app corresponding to the received voice input and perform a specified operation through the executed app.

In an example embodiment, when the user terminal 201 provides a service together with the intelligent server 300 and/or the service server 400, the user terminal 201 may detect a user utterance by using the microphone 270 and generate a signal (or voice data) corresponding to the detected user utterance. The user terminal 201 may transmit the voice data to the intelligent server 300 by using the communication interface 290.

In response to the voice input received from the user terminal 201, the intelligent server 300 according to an example embodiment may generate a plan for performing a task corresponding to the voice input, or a result of performing an action according to the plan. The plan may include, for example, a plurality of actions for performing a task corresponding to the voice input of the user and/or a plurality of concepts related to the plurality of actions. The concepts may define parameters input to the execution of the plurality of actions or result values output by the execution of the plurality of actions. The plan may include relation information between a plurality of actions and/or a plurality of concepts.

The user terminal 201 according to an example embodiment may receive the response by using the communication interface 290. The user terminal 201 may output a voice signal generated in the user terminal 201 by using the speaker 255 to the outside, or output an image generated in the user terminal 201 by using the display 260 to the outside.

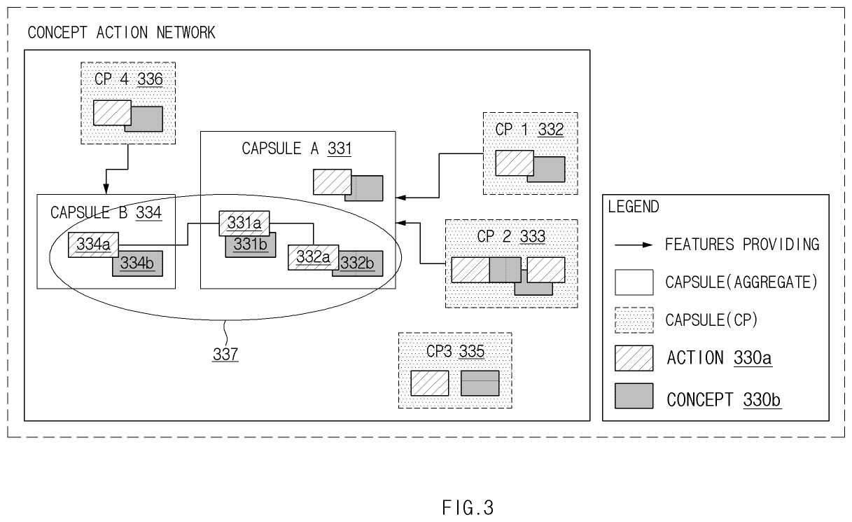

FIG. 3 is a diagram illustrating a form in which information on relation between concepts and actions is stored in a database, according to an example embodiment.

A capsule database (e.g., the capsule database 330) of the intelligent server 300 may store a capsule in the form of a concept action network (CAN). The capsule database may store an action for processing a task corresponding to a voice input of the user and a parameter necessary for the action in the form of the concept action network (CAN).

The capsule database may store a plurality of capsules. According to an example embodiment, the plurality of capsules may include a capsule A 331 and a capsule B 334 corresponding to a plurality of domains (e.g., applications), respectively. According to an example embodiment, one capsule (e.g., the capsule A 331) may correspond to one domain (e.g., location (geo), application). In addition, one capsule may correspond to a capsule of at least one service provider (e.g., CP 1 332, CP 2 333, CP3 335, and/or CP4 336) for performing a function for a domain related to the capsule. According to an example embodiment, one capsule may include at least one action 330a and at least one concept 330b for performing a specified function.

The natural language platform 320 may generate a plan for performing a task corresponding to the voice input received by using a capsule stored in the capsule database 330. For example, the planner module 325 of the natural language platform may generate a plan by using a capsule stored in the capsule database. For example, a plan 337 may be generated by using actions 331a and 332a and concepts 331b and 332b of the capsule A 331 and an action 334a and a concept 334b of the capsule B 334.

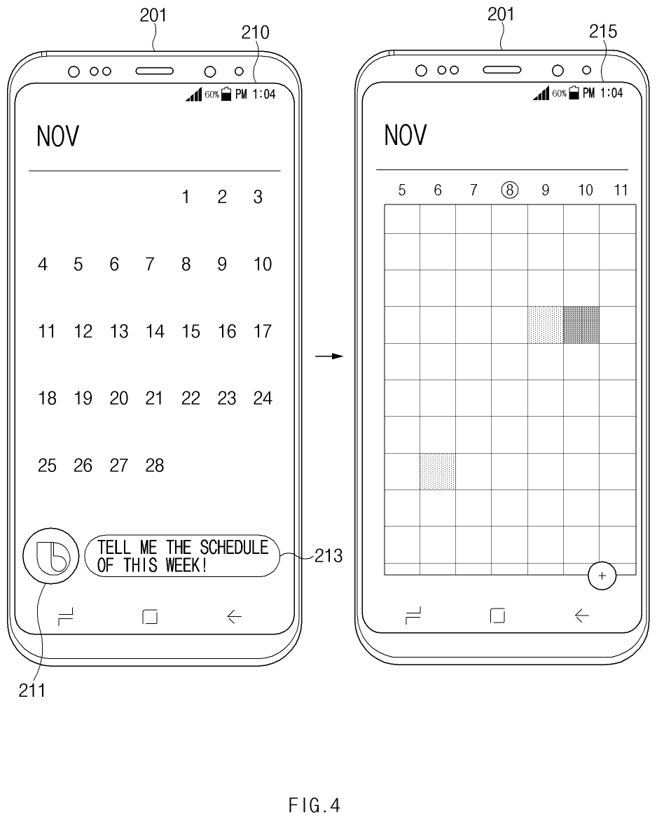

FIG. 4 is a diagram illustrating a screen in which the user terminal processes a voice input received through the intelligent app, according to an example embodiment.

The user terminal 201 may execute an intelligent app to process the user input through the intelligent server 300.

According to an example embodiment, if a specified voice input (e.g., wake up!) is recognized or an input is received through a hardware key (e.g., dedicated hardware key), on a first screen 210, the user terminal 201 may execute the intelligent app to process the voice input. The user terminal 201 may, for example, execute the intelligent app in a state in which the schedule app is being executed. According to an example embodiment, the user terminal 201 may display an object (e.g., an icon) 211 corresponding to the intelligent app on the display 260. According to an example embodiment, the user terminal 201 may receive a voice input by a user utterance. For example, the user terminal 201 may receive a voice input saying “Tell me the schedule of the week!”. According to an example embodiment, the user terminal 201 may display a user interface (UI) 213 (e.g., an input window) of the intelligent app in which text data of the received voice input is displayed on the display.

According to an example embodiment, on the second screen 215, the user terminal 201 may display a result corresponding to the received voice input on the display. For example, the user terminal 201 may receive a plan corresponding to the received user input, and display ‘schedule of this week’ on the display according to the plan.

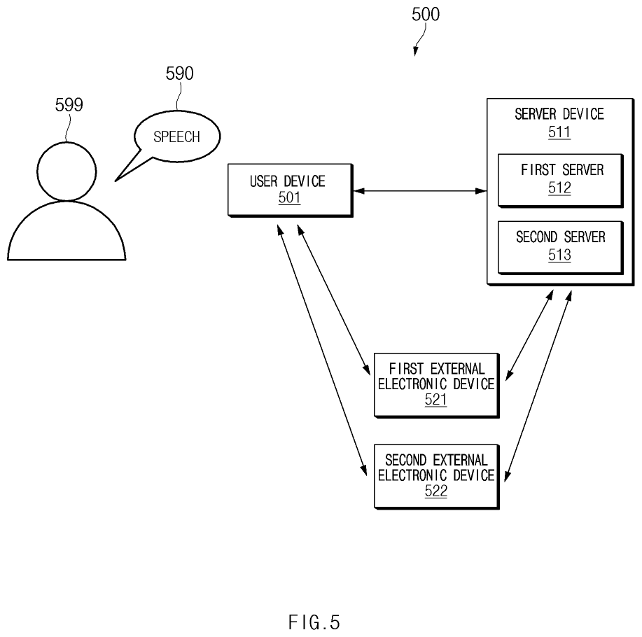

FIG. 5 illustrates a system for performing an action based on an utterance, according to an example embodiment.

Referring to FIG. 5, a system 500 may include a user device 501, a server device 511, a first external electronic device 521, and a second external electronic device 522.

The user device 501 may be referred to as a listener device that receives utterance 590 of a user 599, and may include components similar to those of the user terminal 201 of FIG. 2 or the electronic device 101 of FIG. 1. The user device 501 may include a voice assistant (e.g., the client module 231 of FIG. 2). The user device 501 may be configured to receive the utterance 590 of the user 599 using a voice receiving circuitry (e.g., the audio module 170 of FIG. 1), and transmit utterance data corresponding to the utterance 590 to the server device 511. For example, the user device 501 may be configured to transmit utterance data to the server device 511 through a network such as the Internet.

A target device may be referred to as a device to be controlled by the utterance 590. For example, the target device of the utterance 590 may be referred to as at least one of the user device 501, the first external electronic device 521, and/or the second external electronic device 522. Each of the first external electronic device 521 and the second external electronic device 522 may include components similar to those of the electronic device 101 of FIG. 1.

For example, the target device (e.g., the first external electronic device 521 and/or the second external electronic device 522) may be configured to receive control data from the server device 511 through a network such as the Internet and perform an operation according to the control data. For another example, the target device may be configured to receive the control data from the listener device (e.g., the user device 501) (through a local area network (e.g., NFC, WiFi, LAN, Bluetooth, or D2D) or RF signal), and perform an operation according to the control data.

The server device 511 may include at least one server device. For example, the server device 511 may include a first server 512 and a second server 513. The server device 511 may be configured to receive utterance data from the user device 501 and process the utterance data. For example, the first server 512 may correspond to the intelligent server 300 of FIG. 2. The second server 513 may include a database for the external electronic device 521. The second server 513 may be referred to as an Internet-of-things (IoT) server. For example, the second server 513 may store information about the external electronic device (e.g., an identifier of the external electronic device, group information, or the like), and may include components for controlling the external electronic device. The first server 512 may determine the intent of the user 599 included in the received utterance data by processing the received utterance data. For example, when the intent of the user 599 is to control an external device (e.g., the first external electronic device 521 and the second external electronic device 522), the first server 512 may use data of the second server 513 to identify the target device to be controlled, and may control the target device so that the identified target device performs an action according to the intent. Although the first server 512 and the second server 513 are illustrated as separate components in FIG. 5, the first server 512 and the second server 513 may be implemented as one server.

According to an example embodiment, speech recognition for the utterance 590, intent identification, and control of the target device may be performed by one entity or various entities. Examples of the disclosure may include various aspects of speech recognition, intent identification, and control of the target device, as described below.

In an example, the utterance data transmitted by the user device 501 to the server device 511 may have any type of file format in which voice is recorded. In this case, the server device 511 may determine the intent of the user 599 for the utterance data through speech recognition and natural language analysis of the utterance data. In an example, the utterance data transmitted by the user device 501 to the server device 511 may include a recognition result of speech corresponding to the utterance 590. In this case, the user device 501 may perform automatic speech recognition on the utterance 590 and transmit a result of the automatic speech recognition to the server device 511 as the utterance data. In this case, the server device 511 may determine the intent of the user 599 for the utterance data through natural language analysis of the utterance data.

In an example, the target device may be controlled based on a signal from the server device 511. When the intent of the user 599 is to control the target device, the server device 511 may transmit control data to the target device to cause the target device to perform an action corresponding to the intent. In an example, the target device may be controlled based on a signal from the user device 501. When the intent of the user 599 is to control the target device, the server device 511 may transmit, to the user device 501, information for controlling the target device. The user device 501 may control the target device using information received from the server device 511.

In an example, the user device 501 may be configured to perform automatic speech recognition and natural language understanding. The user device 501 may be configured to directly identify the intent of the user 599 from the utterance 590. In this case, the user device 501 may identify the target device using the information stored in the second server 513 and control the target device according to the intent. The user device 501 may control the target device through the second server 513 or may directly transmit a signal to the target device to control the target device.

In an example, the system 500 may not include the server device 511. For example, the user device 501 may be configured to perform all of the actions of the server device 511 described above. In this case, the user device 501 may be configured to identify the intent of the user 599 from the utterance 590, identify the target device corresponding to the intent from an internal database, and directly control the target device.

The various examples described above with reference to FIG. 5 are various examples capable of controlling the target device based on the utterance, and embodiments of the disclosure are not limited thereto. It should be understood to those skilled in the art that the control methods of the disclosure described below may be carried out using the system of various examples described above with reference to FIG. 5.

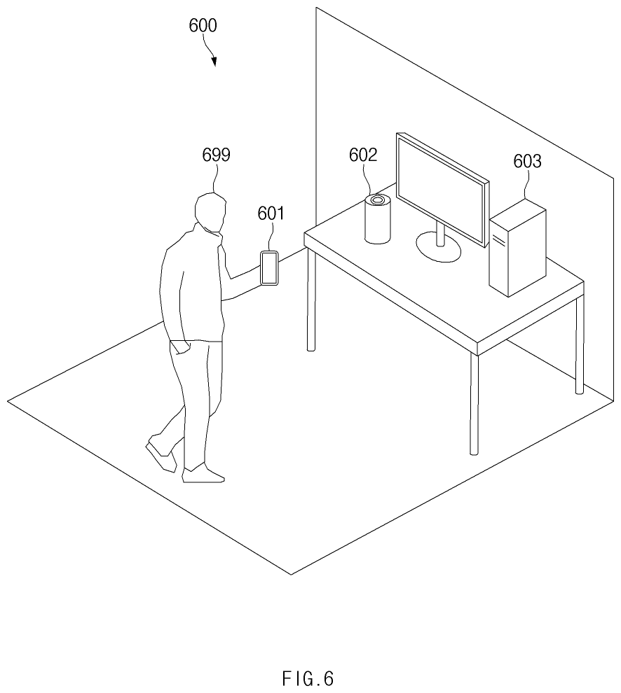

FIG. 6 illustrates a multi-device environment according to an example embodiment.

According to an example embodiment, the system 500 may support a quick command and reorganization (e.g., editing) of the quick command to be described below with reference to FIGS. 6 to 14. Hereinafter, various examples of the disclosure may be described with reference to FIGS. 6 to 14.

Referring to FIG. 6, the multi-device environment 600 may include a first electronic device 601, a second electronic device 602, and a third electronic device 603. According to an example embodiment, the first electronic device 601 may be the user device 501 of FIG. 5, the second electronic device 602 may be the first external electronic device 521 of FIG. 5, and the third electronic device 603 may be the second external electronic device 522 of FIG. 5. In FIG. 6, the first electronic device 601 is illustrated as a mobile phone, the second electronic device 602 is illustrated as an AI speaker, and the third electronic device 603 is illustrated as a personal computer (PC), but each of the first electronic device 601, the second electronic device 602, and the third electronic device 603 may be any electronic device. For example, the multi-device environment 600 may include at least a portion of the system 500 of FIG. 5.

According to an example embodiment, each of the first electronic device 601, the second electronic device 602, and the third electronic device 603 may support execution of a quick command. In the disclosure, the term “quick command” may be a specified utterance associated with a plurality of actions (e.g., tasks). For example, the specified utterance associated with a plurality of actions may be specified by a user 699 or a manufacturer of a user device (e.g., the first electronic device 601). A plurality of actions associated with the specified utterance may be specified by the user 699 or the manufacturer of the user device. For example, the first electronic device 601 may be configured to, if the utterance of the user 699 corresponds to the quick command, perform a plurality of actions associated with the quick command (e.g., directly or through the second electronic device 602 and/or the third electronic device 603). According to an example embodiment, a quick command may be a short cut command that can be uttered by a user to perform multiple tasks or actions without having to utter separate commands for each or the multiple tasks.

The quick command is an utterance with which or to which a plurality of actions are associated or mapped, and may be personalized by the user 699. According to an example embodiment, a system (e.g., the system 500 of FIG. 5) may include a database that stores a quick command and information on actions mapped or related to the quick command. For example, the database may be located in a device (e.g., the user device 501 and/or the server device 511 of FIG. 5) in which natural language understanding of the utterance is performed. The user 699 may specify an arbitrary utterance or an arbitrary syntax as the quick command, and may specify an arbitrary action in the quick command. Any actions associated with one quick command may be associated with one or more electronic devices. For example, a first action and a second action may be associated with one quick command. In an example, the first action may be performed in the first electronic device 601 and the second action may be performed in the second electronic device 602. The user 699 may specify an electronic device to perform each action.

For example, the quick command may have a relatively high priority compared to other utterances. A system for executing the quick command (e.g., the system 500 of FIG. 5) may be configured to, if the quick command is detected from an utterance in the natural language understanding process, perform actions mapped to the quick command, instead of performing an action in another domain.

For example, three actions: “weather alert (first action)”, “stock index notification (second action)”, and “schedule reminder (third action)” may be mapped to a quick command called “briefing”. The system may be configured to, if the quick command “briefing” is exactly matched from an utterance, perform the action mapped to the quick command. For example, the first action and the third action may be associated with the first electronic device 601, and the second action may be associated with the second electronic device 602. The system may be configured to, in response to the quick command “briefing”, perform the first action and the third action in the first electronic device 601 and perform the second action in the second electronic device 602.

According to an example embodiment, embodiments of the disclosure may support reorganization or modification (e.g., editing) of a quick command as described below. For example, if a specified edit command is included in the utterance, actions associated with the quick command may be reorganized based on the edit command. The edit command is a specified word, and actions associated with the quick command may be reorganized in a real-time manner if the edit command and the quick command are recognized together from the utterance.

In the disclosure, it may be assumed that the quick command and the edit command are recognized (e.g., recognized together) from one continuous utterance. For example, one continuous utterance may mean the utterance of the user 699 that has been recognized within one continuous speech recognition section. The first electronic device 601 may be configured to, when the first electronic device 601 recognizes an utterance, recognize the utterance for a specified time or recognize the utterance until a specified command (e.g., a command instructing end of the utterance) is recognized. Even if speech recognition (e.g., STT) is performed in units of syllables or words, determination of intent for utterance (e.g., natural language understanding) may be performed on all utterances made within one speech recognition section. Therefore, even if the edit command and the quick command are commands separated in a phonetic sense, they may be semantically included in one sentence. In this case, the user 699 may intend to edit the quick command based on the edit command.

The edit command may include, for example, a skip word instructing exclusion of at least some of the actions associated with the quick command and/or an adding word for adding a new action to the quick command. For example, the skip word may include at least one of “without”, “skipping”, “excluding”, or “other than”. For example, adding words may include at least one of “with”/“along with”, “including”, “adding/in addition to”, “also”, or “and”.

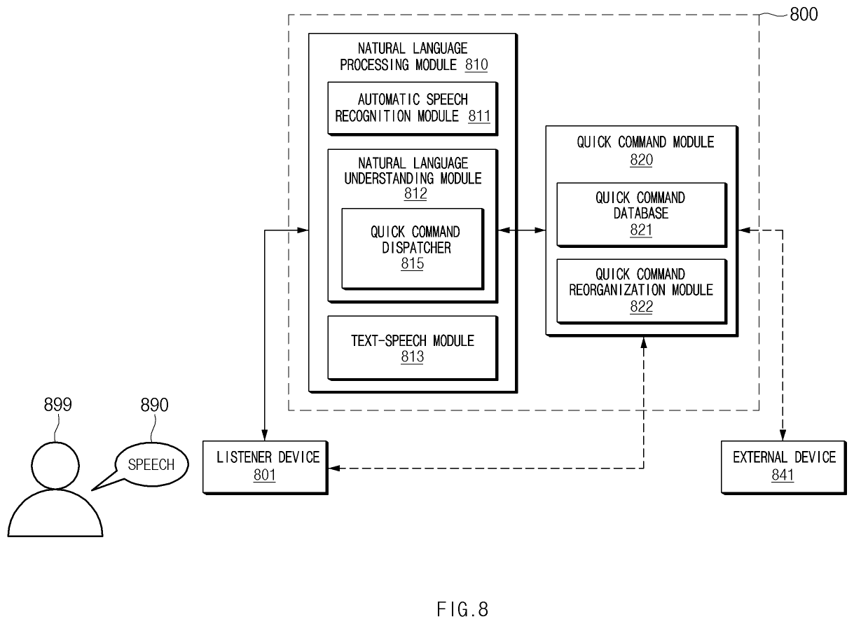

According to an example embodiment, actions of the quick command may be reorganized based on an utterance adjacent to the edit command (e.g., adjacent in word order). For example, “adjacent utterance” is an utterance that precedes or follows an edit command, and may mean an utterance that is continuous in word order. The “adjacent utterance” may correspond to an “adjacent entity” to be described later with reference to FIG. 8. For example, if the utterance is “briefing without computer”, the utterance may include an edit command “without” and the quick command “briefing”. In this case, among the actions associated with the quick command, remaining actions, except for the action performed by the “computer”, may be performed. For an example, if the utterance is “briefing including stock indices”, the utterance may include an edit command “including” and the quick command “briefing”. In this case, in addition to the actions associated with the quick command, an action for a stock index guide may be additionally performed. Hereinafter, various methods for reorganizing actions related to the quick command may be described.

In the disclosure, the term “quick command” is a term referring to one utterance associated with a plurality of actions, and it will be apparent to those skilled in the art that any term may be used therefor. For example, terms such as shortcut, shortcut command, abbreviation and/or short form command may be used instead of “quick command”.

In the disclosure, the term “edit command” is a term referring to one utterance specified for editing of the quick command, and it will be apparent to those skilled in the art that any term may be used therefor. For example, terms such as modification command, amendment, change command, and/or revision may be used instead of “edit command”.

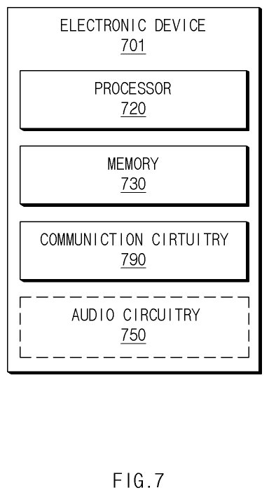

FIG. 7 illustrates a block diagram of an electronic device according to an example.

Referring to FIG. 7, according to an example embodiment, an electronic device 701 may include a processor 720 (e.g., the processor 120 of FIG. 1), a memory 730 (e.g., the memory 130 of FIG. 1), and/or a communication circuitry 740 (e.g., the communication module 190 of FIG. 1). For example, the electronic device 701 may further include an audio circuitry 750 (e.g., the audio module 170 of FIG. 1), and may further include a component not shown in FIG. 7. For example, the electronic device 701 may further include at least some components of the electronic device 101 of FIG. 1.

In various example embodiments of the disclosure, the electronic device 701 may be referred to as a device for reorganizing a quick command. For example, if reorganization of the quick command is performed in a server device (e.g., the server device 511 of FIG. 5), the electronic device 701 may be referred to as a server device. For example, if reorganization of the quick command is performed in a user device (e.g., the user device 501 of FIG. 5), the electronic device 701 may be referred to as a user device. The electronic device 701 may directly control a device associated with the quick command (e.g., a device that performs an action of the quick command) or may control a device associated with the quick command through another device.

The processor 720 may be electrically, operatively, or functionally connected to the memory 730, the communication circuitry 740, and/or the audio circuitry 750. In the disclosure, when one component is referred to as being “operatively” connected to another component, it may mean that the component is connected to operate the other component. For example, one component may operate another component by transmitting a control signal to the other component, either directly or via the still another component. In the disclosure, when one component is referred to as being “functionally” connected to another component, it may mean that the component is connected to execute a function of the other component. For example, one component may execute a function of another component by transmitting a control signal to the other component, either directly or via another component.

The memory 730 may store instructions. When the instructions are executed by the processor 720, the instructions may cause the electronic device 701 to perform various actions.

The electronic device 701 may, for example, acquire user utterance data and identify a control function corresponding to the user utterance data by using the user utterance data. The electronic device 701 may acquire the user utterance data by using the audio circuitry 750 or may acquire utterance data from an external electronic device by using the communication circuitry 740. The electronic device 701 may be configured to identify an intent corresponding to the user utterance data, identify the control function (e.g., the quick command and/or edit command) corresponding to the intent, and identify at least one external electronic device supporting the control function by using function information on a plurality of external electronic devices.

FIG. 8 illustrates a system for quick command reorganization according to an example embodiment.

Referring to FIG. 8, the system may include various modules for performing a quick command based on an utterance 890 of a user 899. The utterance 890 may be a voice command by a user. The term “module” in the description with reference to FIG. 8 refers to a software module, and may be implemented by instructions being executed by a hardware, such a processor, a central processing unit (CPU) or other electronic circuitry. Each module may be implemented on the same hardware or may be implemented on different hardware.

According to an example embodiment, a listener device 801 is a device in which a voice assistant is installed, and may receive the utterance 890 of the user 899 and transmit utterance data corresponding to the utterance 890 to a server device 800. According to an example embodiment, the listener device 801 may be the user device 501 of FIG. 5. For example, the listener device 801 may activate a voice assistant application and activate a microphone (e.g., the audio circuitry 750 of FIG. 7), in response to a wake-up utterance, a button input, or a touch input. The listener device 801 may transmit utterance data corresponding to the received utterance 890 to the server device by using the microphone. The listener device 801 may transmit information about the listener device 801 together with the utterance data to the server device. For example, the information about the listener device 801 may include an identifier of the listener device, a list of functions of the listener device, a status of the listener device (e.g., power status, playback status), and/or location information (e.g., latitude and longitude, or information on a connected access point (AP) (e.g., service set identifier (SSID))). The listener device 801 may provide a result of processing by the server to the user 899 through a speaker or a display. The result processed by the server may include a natural language expression indicating the result of the utterance 890 being processed. In an example, the listener device 801 may include a display, and may be configured to provide various user interfaces (UIs) for registration of a quick command through the display.

According to an example embodiment, the server device 800 may include a natural language processing module 810 and a quick command module 820. According to an example embodiment, the server device 800 may be the server device 511 of FIG. 5. The configurations of the server device 800 illustrated in FIG. 8 are exemplary, and as such, the disclosure are not limited thereto. For example, the server device 800 may further include components of the intelligent server 300 of FIG. 2, such as a front end (e.g., the front end 310 of FIG. 2) according to another example embodiment.

The natural language processing module 810 may identify user intent based on the utterance data received from the listener device 801. For example, the natural language processing module 810 may correspond to the intelligent server 300 of FIG. 2 (e.g., the first server 512 of FIG. 5). The natural language processing module 810 may include an automatic speech recognition module 811, a natural language understanding module 812, and a text-to-speech module 813. The automatic speech recognition module 811 (e.g., the automatic speech recognition module 321 of FIG. 2) may generate text data from utterance data by performing speech recognition on the utterance data. The natural language understanding module 812 (e.g., the natural language understanding module 323 of FIG. 2) may identify the intent of the user by performing natural language understanding on text data. For example, the natural language understanding module 812 may identify an intent corresponding to the utterance 890 by comparing a plurality of predefined intents with text data. Further, the natural language understanding module 812 may extract additional information from the utterance data. For example, the natural language understanding module 812 may perform slot tagging or slot filling by extracting words (e.g., entities) included in the utterance data. The text-to-speech module 813 (e.g., the text-to-speech module 329 of FIG. 2) may be configured to convert feedback in a text format corresponding to the identified intent into a speech format. In an example, the converted voice feedback may be provided to the user 899 via the listener device 801.

The natural language understanding module 812 may include a quick command dispatcher 815. The natural language understanding module 812 may determine whether a specified command (e.g., a quick command) is included in the utterance data corresponding to the utterance 890. In an example, the quick command may have a relatively high priority compared to other intents that may be identified from the utterance. If the quick command is identified from the utterance data, the natural language understanding module 812 may analyze a pattern of the utterance 890 by using the quick command dispatcher 815. In this case, in response to the identification of the quick command, identification of other intents in the utterance 890 may be omitted.

The quick command dispatcher 815 may analyze the pattern of the utterance included in the utterance data. For example, if the quick command is identified from the utterance 890, the quick command dispatcher 815 may determine whether the utterance 890 includes an edit command. For example, the quick command dispatcher 815 may determine, based on the identification of the edit command, that the intent of the utterance 890 of the user 899 includes editing the quick command. If the intent of the utterance 890 includes editing of the quick command, the natural language processing module 810 may reorganize the quick command by transmitting natural language information corresponding to the utterance data to the quick command module 820.

The quick command module 820 may include a quick command database 821 and a quick command reorganization module 822. The quick command database 821 may include information on at least one quick command associated with the listener device 801 or the user 899 (e.g., a user account). The information on the quick command may include, for example, the quick command, device type (e.g., device identification information), keyword, and/or action (e.g., task) information. The device type is information for identifying a device associated with the quick command, and may include information for identifying any device. The keyword may be referred to as a keyword for identifying an action associated with the quick command or a natural language expression for performing the action. The keyword may include, for example, a keyword for identifying a task instructing a specific action (e.g., an action to be added) or a natural language expression (e.g., a target utterance) to perform the action. The device type and keyword are examples of information for identifying the action to be edited, and may be referred to as action information. Table 1 below shows information on quick commands stored in a quick command database according to an example.

TABLE 1

| | Quick | Device | | |
|---|---|---|---|---|
| Index | Command | Type | Keyword | Action |
| 1 | Working | PC | First Application | Execute First |
| | from | | | Application |
| | Home | MOBILE | Do Not Disturb | Execute Do Not |
| | | PHONE | | Disturb Mode |
| | | SPEAKER | Second | Play Music in |
| | | | Application/ | Second |
| | | | Music | Application |
| 2 | Briefing | MOBILE | Weather | Weather Alert |
| | | PHONE | | |
| | | MOBILE | Calendar/ | Schedule |
| | | PHONE | Schedule | Reminder |
| | | MOBILE | News | News Alarm |
| | | PHONE | | |

The quick command reorganization module 822 may receive the utterance tagged by the natural language processing module 810 (e.g., text information corresponding to the utterance 890 processed by the natural language processing module 810 through the speech recognition). The quick command reorganization module 822 may identify the quick command from the tagged utterance (hereinafter, referred to as a recognized utterance). The quick command reorganization module 822 may identify actions mapped to the identified quick command by using information stored in the quick command database 821. According to an example embodiment, the quick command reorganization module 822 may use the identified edit command from the recognized utterance and an entity adjacent to the edit command (e.g., device type or keyword) to reorganize (e.g., modify or edit) actions for the identified quick command). For example, if the entity identified adjacent to the edit command indicates a device type, the quick command reorganization module 822 may reorganize the quick command by editing an action corresponding to the indicated device type based on the edit command. For example, if the entity identified adjacent to the edit command indicates a specified keyword, the quick command reorganization module 822 may reorganize the quick command by editing an action corresponding to the indicated keyword based on the edit command.

Referring to Table 1, in an example, the utterance 890 may be “working from home without PC”. Since the utterance 890 includes “working from home” registered as the quick command, the quick command reorganization module 822 may identify actions associated with “working from home” from information stored in the quick command database 821. The quick command reorganization module 822 may identify an edit command “without” from the recognized utterance. In addition, the quick command reorganization module 822 may identify an entity “PC”, which is adjacent to the edit command. The quick command reorganization module 822 may reorganize actions of the identified quick command by using the edit command and the adjacent entity (e.g., device type information or keyword). In the present example, the quick command reorganization module 822 may reorganize actions associated with “working from home” with remaining actions except for the action associated with the PC (e.g., execution of the first application), among the actions associated with “working from home”. The server device 800 may perform reorganized actions. For example, the server device 800 may set the “do not disturb” mode in the mobile phone (e.g., the listener device 801), and play music on the speaker (e.g., the external device 841) by using the second application.

Referring to Table 1, in an example, the utterance 890 may be “working from home without music”. Since the utterance 890 includes “working from home” registered as the quick command, the quick command reorganization module 822 may identify actions associated with “working from home” from information stored in the quick command database 821. The quick command reorganization module 822 may identify the edit command “without” from the recognized utterance. In addition, the quick command reorganization module 822 may identify an entity “music”, which is adjacent to the edit command. The quick command reorganization module 822 may reorganize actions of the identified quick command by using the edit command and the adjacent entity (e.g., device type information or keyword). In the present example, the quick command reorganization module 822 may reorganize actions associated with “working from home” with remaining actions except for the action associated with music (e.g., music playback in the second application), among the actions associated with “working from home”. The server device 800 may perform reorganized actions. For example, the server device 800 may execute the first application in the PC and set the “do not disturb” mode in the mobile phone (e.g., the listener device 801).

Referring to Table 1, in an example, the utterance 890 may be “a briefing other than the weather”. Since the utterance 890 includes “briefing” registered as the quick command, the quick command reorganization module 822 may identify actions associated with “briefing” from information stored in the quick command database 821. The quick command reorganization module 822 may identify an edit command “other than” from the recognized utterance. In addition, the quick command reorganization module 822 may identify an entity “weather”, which is adjacent to the edit command. The quick command reorganization module 822 may reorganize actions of the identified quick command by using the edit command and the adjacent entity (e.g., device type information or keyword). In the present example, the quick command reorganization module 822 may reorganize actions associated with “briefing” with remaining actions except for the action associated with music (e.g., weather alert), among the actions associated with “briefing”. The server device 800 may perform reorganized actions. For example, the server device 800 may issue notification of schedules and news through a mobile phone (e.g., the listener device 801).

With reference to Table 1, in an example, the utterance 890 may be “briefing including stock indices.” Since the utterance 890 includes “briefing” registered as the quick command, the quick command reorganization module 822 may identify actions associated with “briefing” from information stored in the quick command database 821. The quick command reorganization module 822 may identify an edit command “including” from the recognized utterance. In addition, the quick command reorganization module 822 may identify an entity “stock index”, which is adjacent to the edit command. The quick command reorganization module 822 may reorganize actions of the identified quick command by using the edit command and the adjacent entity (e.g., device type information or keyword). According to an example embodiment, the quick command reorganization module 822 may reorganize actions associated with “briefing” by adding an action of stock index notification together with actions associated with “briefing”. The server device 800 may perform reorganized actions. For example, the server device 800 may provide information on weather, schedule, news, and stock indices through a mobile phone (e.g., the listener device 801).

In the example of Table 1, the quick command database 821 has been described as including information on the keyword, but embodiments of the disclosure are not limited thereto. For example, the quick command database 821 may not include information on the keyword. In an example embodiment, the quick command reorganization module 822 may identify an action to be edited based on an action similarity with an entity adjacent to the edit command of the recognized utterance. For example, in the example of Table 1, information about a keyword for an action associated with the speaker may not exist. Even in this case, if the similarity between a parameter (e.g., music and the second application) associated with the action and an adjacent entity is equal to or greater than a specified value, the quick command database 821 may identify the action associated with the speaker from the adjacent entity. The above-described similarity may include pronunciation similarity and/or semantic similarity. According to an example embodiment, the similarity may be indicated by a similarity value, which indicates a level of similarity between a first parameter A and a second parameter B. As such, if a similarity value indicating a level of similarity between a parameter (e.g., music and the second application) associated with the action and an adjacent entity is equal to or greater than a specified value, the quick command database 821 may identify the action associated with the speaker from the adjacent entity.

According to an example embodiment, the quick command reorganization module 822 may reorganize the quick command based on the order of words (e.g., entities) in the utterance 890. If the edit command identified from the utterance 890 instructs addition of a task, the quick command reorganization module 822 may reorganize the quick command based on the order of entities recognized in the utterance 890. The quick command reorganization module 822 may determine whether a task to be added (hereinafter, referred to as an additional task) will be performed before or after a task (hereinafter, referred to as a quick command task) mapped to the quick command, based on the order of recognized entities.

For example, the quick command reorganization module 822 may determine the execution order of the additional task based on the order of the edit command and the quick command in the utterance 890. If the edit command precedes the quick command, the quick command reorganization module 822 may reorganize the quick command so that the additional task is performed before the quick command task. If the quick command precedes the edit command, the quick command reorganization module 822 may reorganize the quick command so that the additional task is performed after the execution of the quick command task.

For example, the quick command reorganization module 822 may determine the execution order of the additional task based on the order of the quick command and the adjacent entity within the utterance 890. If the adjacent entity precedes the quick command, the quick command reorganization module 822 may reorganize the quick command so that the additional task (e.g., a task corresponding to the adjacent entity) is performed before the quick command task. If the quick command precedes the adjacent entity, the quick command reorganization module 822 may reorganize the quick command so that the additional task is performed after the execution of the quick command task.

Referring to Table 1, in an example, the utterance 890 may be “working from home and run the messenger on the desktop”. Since the utterance 890 includes “working from home” registered as the quick command, the quick command reorganization module 822 may identify actions associated with “working from home” from information stored in the quick command database 821. The quick command reorganization module 822 may identify an edit command “and” from the recognized utterance. In addition, the quick command reorganization module 822 may identify an entity (e.g., a target utterance) adjacent to the edit command “run the messenger on the desktop”. The quick command reorganization module 822 may reorganize the quick command so as to execute tasks mapped to “working from home” based on the order of the recognized entities in the utterance 890 and then execute a messenger, which is the additional task, on the desktop.

Referring to Table 1, in an example, the utterance 890 may be “turn on the lights in the living room and working from home.” Since the utterance 890 includes “working from home” registered as the quick command, the quick command reorganization module 822 may identify actions associated with “working from home” from information stored in the quick command database 821. The quick command reorganization module 822 may identify an edit command “and” from the recognized utterance. In addition, the quick command reorganization module 822 may identify an entity (e.g., a target utterance) adjacent to the edit command “turn on the lights in the living room”. The quick command reorganization module 822 may reorganize the quick command so as to turn on the lights in the living room based on the order of recognized entities within the utterance 890 and then execute tasks mapped to “working from home”.

According to an example embodiment, the quick command reorganization module 822 may reorganize the quick command based on the logical order of tasks to be added in words (e.g., entities) in the utterance 890. If the edit command identified from the utterance 890 instructs addition of a task, the quick command reorganization module 822 may reorganize the quick command based on the logical order of the quick command task and the additional task recognized in the utterance 890. For example, the additional task may be a task that logically follows the task of the quick command. That is, the additional task may be a task to be executable only after the quick command task is executed. In this case, the quick command reorganization module 822 may reorganize the quick command so that the logically following task may be executed after the logically preceding task is executed.

Referring to Table 1, in an example, the utterance 890 may be “speaker volume up and working from home”. Since the utterance 890 includes “working from home” registered as the quick command, the quick command reorganization module 822 may identify actions associated with “working from home” from information stored in the quick command database 821. The quick command reorganization module 822 may identify an edit command “and” from the recognized utterance. In addition, the quick command reorganization module 822 may identify an entity (e.g., a target utterance) adjacent to the edit command “speaker volume up”. Speaker volume-up may be premised on playing music on the speaker. In this case, the additional task may be premised on the execution of the task of “play music in the second application” of the quick command. If the additional task is premised on the execution of the task of the quick command as described above, the additional task may be a task that logically follows the task of the quick command. The quick command reorganization module 822 may reorganize the quick command so that logically following “speaker volume up” is executed after the execution of the quick command task.

In the example of FIG. 8, for convenience of description, the server device 800 and the listener device 801 have been described separately, but embodiments of the disclosure are not limited thereto. For example, components of the server device 800 may be implemented in the listener device 801. As described above with reference to FIG. 7, the electronic device 701 of FIG. 7 refers to an electronic device that reorganizes the quick command. For example, if the quick command module 820 is implemented in the server device 800, the electronic device 701 of FIG. 7 may be referred to as the server device 800. For example, if the quick command module 820 is implemented in the listener device 801, the electronic device 701 may be referred to as the listener device 801.

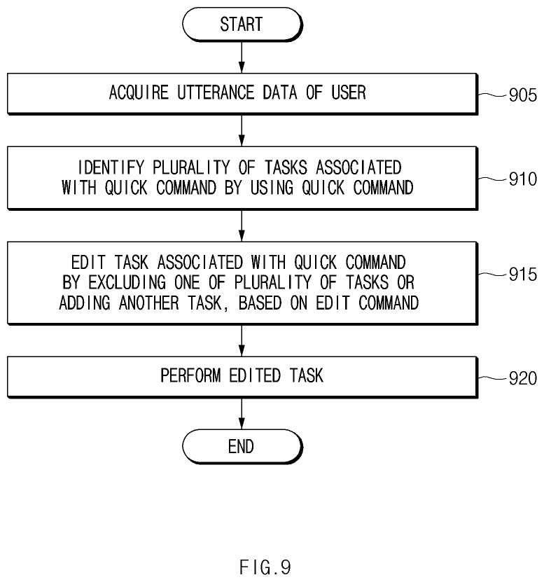

FIG. 9 illustrates a flowchart of a method of performing a task in an example embodiment.

Referring to FIGS. 7 and 9, in operation 905, the electronic device 701 may acquire user utterance data. For example, the electronic device 701 may acquire user utterance data from an external device (e.g., the listener device 801 of FIG. 8). The user utterance data may include voice data corresponding to the utterance of the user or text data corresponding to the utterance of the user. According to another example, the electronic device 701 may acquire utterance data from the user by using the audio circuitry 750 of the electronic device 701.

According to an example embodiment, it may be assumed that the utterance data of the user includes a quick command and an edit command. If the utterance is “working from home without PC”, the electronic device 701 may generate text data (e.g., working from home without PC) corresponding to the utterance. For example, the electronic device 701 may label or tag the text data corresponding to the utterance data. The electronic device 701 may identify (e.g., label or tag) “working from home” as the quick command “without” as the edit command, and “PC” as the adjacent entity (e.g., device type information or keyword information). If the utterance is “briefing including stock indices”, the electronic device 701 may identify “briefing” (see the example in Table 1) as the quick command “including” as the edit command, and “stock index” as the adjacent entity.

In operation 910, the electronic device 701 may identify a plurality of tasks associated with the quick command by using the quick command. According to an example embodiment, the electronic device 701 may identify a task set (i.e., a set of tasks) associated with the quick command. The task set may include the plurality of tasks associated with the quick command. For example, the electronic device 701 may identify a plurality of tasks (e.g., actions) associated with the identified quick command by using a database of quick commands (e.g., the quick command database 821 of FIG. 8) stored in the electronic device 701.

In operation 915, the electronic device 701 may edit (e.g., reorganize) a task associated with the quick command by excluding one task from among the plurality of tasks or adding another task based on the edit command. For example, the electronic device 701 may edit a task associated with the command in real time and/or dynamically based on the edit command. The electronic device 701 may recombine the task associated with the quick command by using the edit command and an entity (e.g., device information or keyword information) uttered adjacent to the edit command. The edit command and the adjacent entity may be referred to as an utterance pattern instructing editing of the quick command.

In response to the identification of the utterance pattern instructing the editing, the electronic device 701 may edit the task associated with the quick command. For example, the electronic device 701 may recombine actions associated with the quick command based on the utterance pattern and information acquired from the quick command database.

For example, the edit command may instruct exclusion of an action, and the adjacent entity may be a device type. In this case, the electronic device 701 may identify an action to be excluded among the actions of the corresponding quick command by using the device type information. The electronic device 701 may reorganize actions of the quick command with the remaining actions except for the identified action.

For example, the edit command may instruct exclusion of an action, and the adjacent entity may include keyword information. In this case, an action to be excluded among actions of the corresponding quick command may be identified by using the keyword information. For example, the electronic device 701 may identify an action to be excluded based on a similarity (e.g., pronunciation and/or meaning) between the keyword information and actions of the quick command. For example, the electronic device 701 may identify, as an action to be excluded, an action having a similarity with the keyword information which is equal to or greater than a specified similarity. The electronic device 701 may reorganize actions of the quick command with the remaining actions except for the identified action.

For example, the edit command may instruct addition of an action, and the adjacent entity may include keyword information. In this case, the electronic device 701 may identify an action (e.g., task) to be additionally performed by using the keyword information. The electronic device 701 may reorganize the action of the quick command by adding an action associated with the keyword information to the actions of the corresponding quick command.

In operation 920, the electronic device 701 may perform the edited task. For example, the electronic device 701 may transmit a control signal to the external electronic device so that the external electronic device performs the edited task. If the electronic device 701 is a listener device and a part of the edited task is associated with the listener device, the electronic device 701 may directly perform the edited task. For example, the processor of the electronic device 701 may control the electronic device 701 to perform the edited task and/or control an external electronic device to perform the task.

The electronic device 701 may feedback information on the edited task to the user. For example, if the electronic device 701 is a server device, the electronic device 701 may provide feedback through the listener device by transmitting, to the listener device, information on reorganized actions (e.g., the list of reorganized actions and/or voice data for the list of reorganized actions). For another example, if the electronic device 701 is a listener device, the electronic device 701 may provide feedback by using a display and/or an audio output circuit.

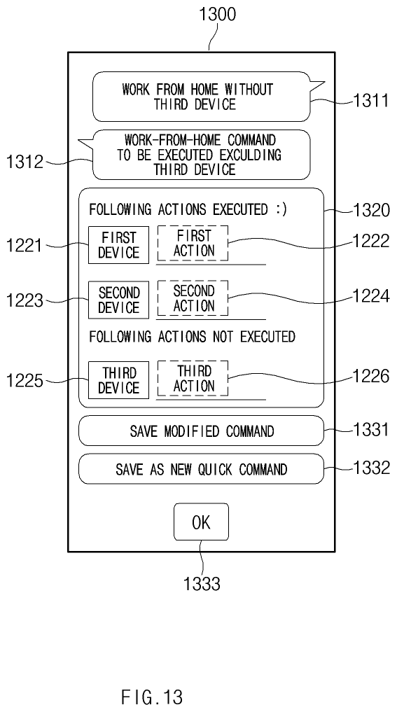

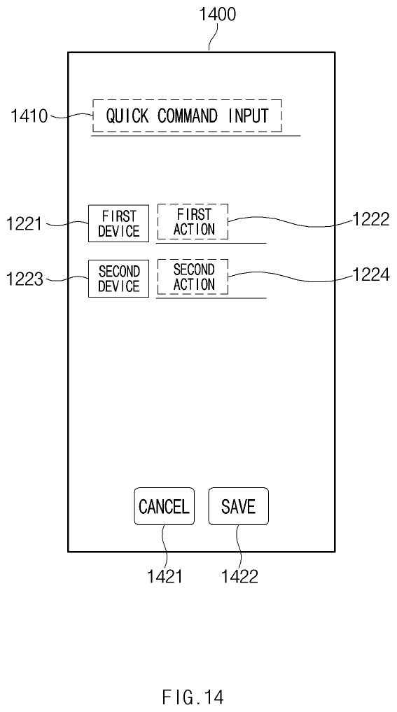

According to an example embodiment, reorganization of the task (e.g., reorganization of actions) may be temporary. For example, the electronic device 701 may temporarily reorganize the task, and after reorganization, save the task associated with the quick command in an original state. However, as will be described later with reference to FIGS. 13 and 14, the electronic device 701 may be configured to provide a UI for saving the reorganized quick command.

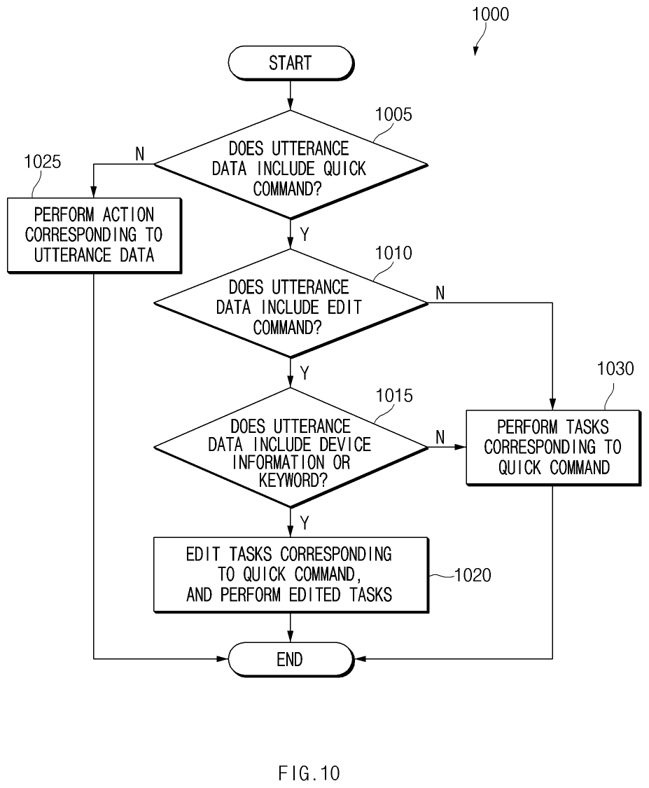

FIG. 10 illustrates a flowchart of a method of performing a task according to an example embodiment.

With reference to a flowchart 1000 of FIGS. 7 and 10, the operations of the flowchart 1000 of FIG. 10 may correspond to operations 910 and 915 of FIG. 9.

In operation 1005, the electronic device 701 may determine whether the utterance data includes a quick command. For example, the electronic device 701 may determine whether the utterance data includes a quick command by using the quick command stored in the quick command database.

If the utterance data does not include the quick command (e.g., NO in operation 1005), in operation 1025, the electronic device 701 may perform an action corresponding to the utterance data. For example, the electronic device 701 may perform an action corresponding to the utterance data based on the speech recognition and intent identification described above with reference to FIG. 2.

If the utterance data includes the quick command (e.g., YES in operation 1005), in operation 1010, the electronic device 701 may determine whether the utterance data includes an edit command. For example, the electronic device 701 may determine whether the utterance data includes an edit command based on the speech recognition for the utterance data. For example, the edit command may include a skip word instructing exclusion of at least some of the actions associated with the quick command and/or an adding word for adding a new action to the quick command. For example, the skip word may include at least one of “without”, “skipping”, “excluding”, or “other than”. For example, adding words may include at least one of “with”/“along with”, “including”, “adding/in addition to”, or “and”.

If the utterance data does not include the edit command (e.g., NO in operation 1010 or does not include the device information and the keyword (e.g., NO in operation 1015), in operation 1030, the electronic device 701 may provide tasks corresponding to the quick command. For example, the electronic device 701 may perform tasks without editing the quick command. Although it has been described in FIG. 10 that tasks corresponding to the quick command are performed if information on actions to be edited is not identified even when the edit command is identified, embodiments of the disclosure are not limited thereto. In this case, the electronic device 701 may be configured to inquire of the user which action to edit.

If the utterance data includes the device information or the keyword (e.g., YES in operation 1015), in operation 1020, the electronic device 701 may edit tasks corresponding to the quick command and perform the edited tasks. For example, the utterance data may be “working from home without PC”. Referring to the example of Table 1 described above, the electronic device 701 may identify the quick command “working from home” and the edit command “without” from the utterance data, and may identify the device information “PC”. In this case, the electronic device 701 may be configured to perform actions other than those associated with the PC among actions associated with “working from home”. For another example, the utterance data may be “working from home without playing music”. Referring to the example of Table 1 described above, the electronic device 701 may identify the quick command “working from home” and the edit command “without” from the utterance data, and may identify the key word “playing music”. The electronic device 701 may be configured to perform actions other than those associated with music playback among actions associated with “working from home”. For another example, the utterance data may be “briefing including stock indices”. Referring to the example of Table 1 described above, the electronic device 701 may identify the quick command “briefing”, the edit command “including”, and the key word “stock indices” from the utterance data. The electronic device 701 may be configured to perform actions associated with notification of stock indices, together with actions associated with “briefing”.

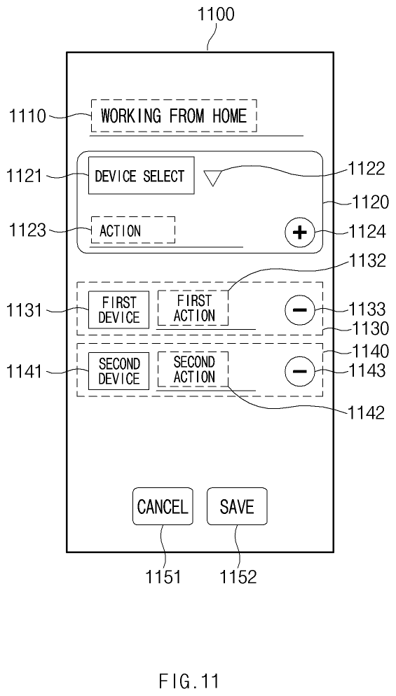

FIG. 11 illustrates a user interface (UI) for editing a quick command according to an example embodiment.

Referring to FIG. 11, a user device (e.g., the listener device 801 of FIG. 8) may provide an editing UI 1100 for editing the quick command. A user may register or edit the quick command by using the editing UI 1100.

A quick command input interface 1110 may indicate the quick command input by the user. For example, the user may specify the quick command through voice utterance or a touch input (e.g., input to a virtual keyboard). The quick command specified by the user may be displayed on the quick command input interface 1110. If an input to the quick command input interface 1110 is received, the user device may provide a new UI for allowing the user to input a new quick command.

An action addition UI 1120 may include a menu for adding an action to the quick command. For example, if an input to a device selection UI 1121 or a drop-down button 1122 is received, the user device may provide a list of electronic devices registered in a user account of the user device. The user may select a device to perform an action through an input for the provided list of electronic devices. If a device is selected, the selected device may be displayed on the device selection UI 1121. For example, if an input to an action UI 1123 is received, the user device may provide a list of actions that may be performed by the selected device. The user may select an action to be performed through an input for the provided list of actions. If an action is selected, the selected action may be displayed on the action UI 1123. After selecting the device and the action, the user may add the action to the quick command through an input to an add button 1124.

Under the action addition UI 1120, a list of actions associated with the current corresponding quick command may be displayed. For example, first action information 1130 may include information 1132 on a first action and information 1131 on a device to perform the first action. For example, second action information 1140 may include information 1142 on a second action and information 1141 on a device to perform the second action.

For example, the editing UI 1100 may include a deletion interface for deletion of an action associated with the quick command. For example, if an input to a first delete button 1133 is received, the user device may delete the first action from among the actions of the corresponding quick command. For example, if an input to a second delete button 1143 is received, the user device may delete the second action from among the actions of the corresponding quick command.

If an input to a cancel button 1151 is received, the user device may cancel the modification of the quick command and end the provision of the editing UI 1100. If an input to a save button 1152 is received, the user device may save the modification of the quick command and end the provision of the editing UI 1100.

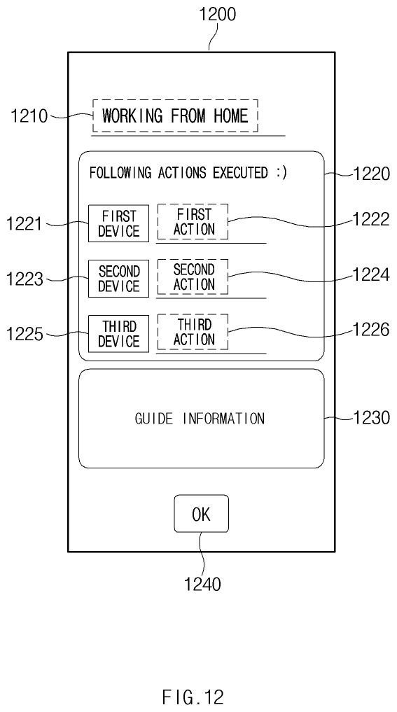

FIG. 12 illustrates an execution screen of a quick command according to an example embodiment.

Referring to FIG. 12, a user device (e.g., the listener device 801 of FIG. 8) may provide an execution screen 1200. For example, the execution screen 1200 may include quick command information 1210 indicating an executed quick command. The execution screen 1200 may also include information 1220 on executed actions. In the example of FIG. 12, the information 1220 on executed actions may include first device information 1221, first action information 1222 performed in the first device, second device information 1223, second action information 1224 performed in the second device, the second motion information 1224, third device information 1225, and third action information performed in the third device.

In an example, the execution screen 1200 may include guide information 1230. The guide information 1230 may include, for example, guide information on utterances for real-time editing of the quick command. By providing the method of editing the quick command based on the edit command, the user may intuitively edit the quick command.

If an input to an OK button 1240 is received, the user device may end display of the execution screen 1200.

FIG. 13 illustrates an edited execution screen of a quick command according to an example embodiment.

Referring to FIG. 13, a user device (e.g., the listener device 801 of FIG. 8) may provide an execution screen 1300 after executing the edited quick command based on the edit command.

The execution screen 1300 may include utterance information 1311 corresponding to the utterance and feedback 1312 on the utterance information. In the example of FIG. 13, the utterance data indicated by the utterance information 1311 may include the quick command “working from home”, the edit command “without”, and the device type information “device 3”. The feedback 1312 may include information on an action or device excluded based on the above edit command.

Information 1320 on executed actions may include information on executed actions and information on unexecuted actions. In the example of FIG. 13, it may be assumed that a first action and a second action are executed, but a third action is not executed.

According to an example embodiment, the user device may provide a UI for saving the edited quick command. For example, the execution screen 1300 may include a first button 1331 for saving the modified quick command and a second button 1332. If an input to the first button 1331 is received, the user device may save the modified quick command. For example, the user device may delete the third action from among actions associated with working from home. When an input to the second button 1332 is received, the user device may provide a UI (refer to FIG. 14) for mapping modified actions to a new quick command.

If an input to an OK button 1333 is received, the user device may end display of the execution screen 1300. In this case, the modification to the quick command may be discarded.

FIG. 14 illustrates a UI for saving a new quick command according to an example embodiment.

For example, a user device (e.g., the listener device 801 of FIG. 8) may provide a save UI 1400 for saving a quick command if the input to the second button 1332 of FIG. 13 is received.

The user device may be configured to, if an input to a quick command input interface 1410 is received, provide an interface (e.g., voice recording or virtual keyboard) for inputting a quick command. If a quick command is input from the user, the input quick command may be displayed on the quick command input interface 1410.

If an input to a save button 1422 is received, the user device may map a first action and a second action to the newly input quick command and save the mapping. If an input to the cancel button 1421 is received, the user device may discard information on the edited quick command.

1. An electronic device comprising:
communication circuitry;
a processor; and
memory that stores instructions,
wherein the instructions, when executed by the processor, cause the electronic device to:
obtain utterance data corresponding to voice command of a user, the utterance data including a quick command and an edit command;
identify a task set including a plurality of tasks associated with the quick command based on the quick command;
edit the task set associated with the quick command by excluding a first task from among the plurality of tasks or adding a new task to the task set based on the edit command; and
perform the edited task set.

2. The electronic device of claim 1, wherein the edit command includes a skip word instructing exclusion of the first task from the task set or an add word instructing addition of the new task to the task set.

3. The electronic device of claim 1, wherein the instructions, when executed by the processor, cause the electronic device to:
identify, from the utterance data, the edit command and action information preceding or following the edit command;
identify the first task among the plurality of tasks in the task set based on the identified action information; and
edit the task set associated with the quick command by excluding the first task.

4. The electronic device of claim 3, wherein the instructions, when executed by the processor, cause the electronic device to:
identify the first task associated with device information included in the action information.

5. The electronic device of claim 3, wherein the instructions, when executed by the processor, cause the electronic device to:
identify the first task corresponding to a keyword included in the action information.

6. The electronic device of claim 5, wherein the instructions, when executed by the processor, cause the electronic device to identify the first task to be excluded based on a level of similarity between the first task and keyword being equal to or greater than a specified value.

7. The electronic device of claim 1, wherein the instructions, when executed by the processor, cause the electronic device to:
identify the edit command and action information preceding or following the edit command from the utterance data;
identify an additional task based on the identified action information; and
edit the task set associated with the quick command by adding the additional task.

8. The electronic device of claim 7, wherein the instructions, when executed by the processor, cause the electronic device to:
identify a keyword from the action information; and
identify the additional task corresponding to the identified keyword.

9. The electronic device of claim 1, wherein the instructions, when executed by the processor, cause the electronic device to temporarily edit the task set associated with the quick command in a real-time manner, based on the edit command.

10. The electronic device of claim 1, wherein the utterance data corresponds to an utterance obtained within a specified time interval.

11. A method of reorganizing a quick command of an electronic device, the method comprising:
obtaining utterance data corresponding to a voice command of a user, the utterance data including a quick command and an edit command for editing a task;
identifying a task set including a plurality of tasks associated with the quick command based on the quick command;
editing the task set associated with the quick command by excluding a first task from among the plurality of tasks or adding a new task to the task set based on the edit command; and
performing the edited task set.

12. The method of claim 11, wherein the edit command includes a skip word instructing exclusion of the first task from the task set or an add word instructing addition of the new task to the task set.

13. The method of claim 11, wherein the editing of the task associated with the quick command includes:
identifying, from the utterance data, the edit command and action information preceding or following the edit command;
identifying the first task, among the plurality of tasks in the task set based on the identified action information; and
editing the task set associated with the quick command by excluding the first task from the plurality of tasks associated with the quick command.

14. The method of claim 13, wherein the identifying of the first task among the plurality of tasks comprises identifying the first task associated with device information included in the action information.

15. The method of claim 13, wherein the identifying of the first task among the plurality of tasks comprises identifying the first task corresponding to a keyword included in the action information.

16. An electronic device comprising:
a memory configured to store one or more instructions; and
a processor configured to execute the one or more instructions to:
obtain a voice command from a user, the voice command including a first command and a second command adjacent to the first command;
identify a task set including a plurality of tasks associated with the first command;
generate a modified task set based on the second command; and
control to perform one or more operations based on the modified task set.

17. The electronic device of claim 16, wherein the processor is further configured to generate the modified task set by excluding a first task from task set or adding a second task to the task set based on the second command.

18. The electronic device of claim 16, wherein the one or more operations comprises controlling the electronic device to perform one or more tasks included in the modified task set.

19. The electronic device of claim 16, wherein the one or more operations comprises controlling an external device to perform one or more tasks included in the modified task set.

20. The electronic device of claim 16, wherein the one or more operations comprises performing a save operation to save the modified task set as a new quick command.
